(19) United States
(12) Patent Application Publication
(10) Pub. No.: US 2009/0240385 A1
(43) Pub. Date: Sep. 24, 2009

(54) ELECTRONIC CONTROL APPARATUS FOR VEHICLE

(75) Inventor: Taichi YAMAGUCHI, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/395,795

(22) Filed: Mar. 2, 2009

(30) Foreign Application Priority Data
Mar. 21, 2008 (JP) 2008-74045

(51) Int. Cl. G06F 19/00

(52) U.S. Cl. 701/2; 701/1

(57) ABSTRACT

In an electronic control system for a vehicle, when a switch manipulation signal is inputted from a portable radio device, a control apparatus sets a check condition for switching an air-conditioner from the present condition to a different condition as a check condition for checking a manipulation pattern. The control apparatus checks the manipulation pattern based on the switch manipulation signal and a count value of the number of switch manipulations and checks whether the manipulation pattern meets the check condition of the acceptable pattern. If the manipulation pattern meets the check condition, the control apparatus starts to turn on or off the air-conditioner.

### CROSS REFERENCE TO RELATED APPLICATION

This application is based on and incorporates herein by reference Japanese Patent Application No. 2008-74045 filed on Mar. 21, 2008.

### FIELD OF THE INVENTION

The present invention relates to an electronic control apparatus, which checks an input signal applied from an instruction switch to determine an instructed operation and controls a control object in a vehicle in correspondence to the determined instruction.

### BACKGROUND OF THE INVENTION

In a conventional electronic control system for a vehicle, an external transmitter device (portable radio device) carried by a vehicle user transmits instructions to a vehicle thereby to switch vehicle doors to the lock condition or the unlock condition, switch a vehicle engine to the starting or the stopping, or switch a vehicle air-conditioner to the turn-on condition or the turn-off condition. According to this conventional system, if the portable radio device transmits the same instruction (for example, door unlock instruction) twice, the control system responsively performs the same operation (for example, a sequence of driving a door unlocking actuator, and answering back to the user by blinking hazard lights, etc.) in response to each instruction.

In another conventional electronic control system, a wireless telephone network is used to transmit instructions of a user by a portable radio device from a remote location. JP 2006-77541A proposes to enhance security of vehicles by not transmitting the instruction for door unlocking without any checking, but transmitting it only when a predetermined transmission condition is satisfied. For example, the transmission of the instruction for door unlocking is limited to only within a predetermined time period after the last door locking. However, for such a limiting function, the portable radio device need be configured to check the contents of each instruction, thus resulting in complication of its hardware and software.

In a still other conventional electronic control system, an instruction switch is provided within a vehicle to generate instructions so that a control object in a vehicle such as vehicle doors may be electronically controlled in response to the instructions from such an in-vehicle switch. Since instruction signals of the instruction switch are input to an electronic control apparatus directly, it is not possible to prevent the control apparatus from repeating the same operation unnecessarily even if the portable radio device has the above limiting function.

### SUMMARY OF THE INVENTION

It is therefore an object of the present invention to provide an electronic control apparatus, which limits unnecessary operations of a control object in a vehicle by checking based on an operating condition of the control object whether the operation instructed by an instruction switch is required.

According to one aspect of the present invention, an electronic control apparatus is provided for controlling a control object mounted in a vehicle in response to an input signal from a manipulation switch. The electronic control apparatus is configured to: set an instruction, as an acceptable instruction, that changes the control object from a present operating condition to a different operating condition; check whether the input signal from the manipulation switch corresponds to the acceptable instruction; and control the control object as instructed by the input signal from the manipulation switch only when the input signal from the manipulation switch is determined to be the acceptable instruction.

### BRIEF DESCRIPTION OF THE DRAWINGS

The above and other objects, features and advantages of the present invention will become more apparent from the following description made with reference to the accompanying drawings. In the drawings:

FIG. 1 is a block diagram showing an electronic control apparatus for a vehicle according to an embodiment of the present invention;

FIG. 2 is a table showing a relation between switch manipulation patterns and corresponding control operations performed in the embodiment;

FIG. 3 is a flowchart showing switch manipulation check processing performed in the embodiment;

FIGS. 4A and 4B are time charts showing a check operation of switch manipulation patterns for turning on and off an air-conditioner in the embodiment; and

FIG. 5 is a time chart showing a check operation of switch manipulation patterns in case of interruption of radio communications in the embodiment.

### DETAILED DESCRIPTION OF THE EMBODIMENT

The present invention is described next in detail with reference to an embodiment, in which an air-conditioner of a vehicle is controlled from a remote location of the vehicle.

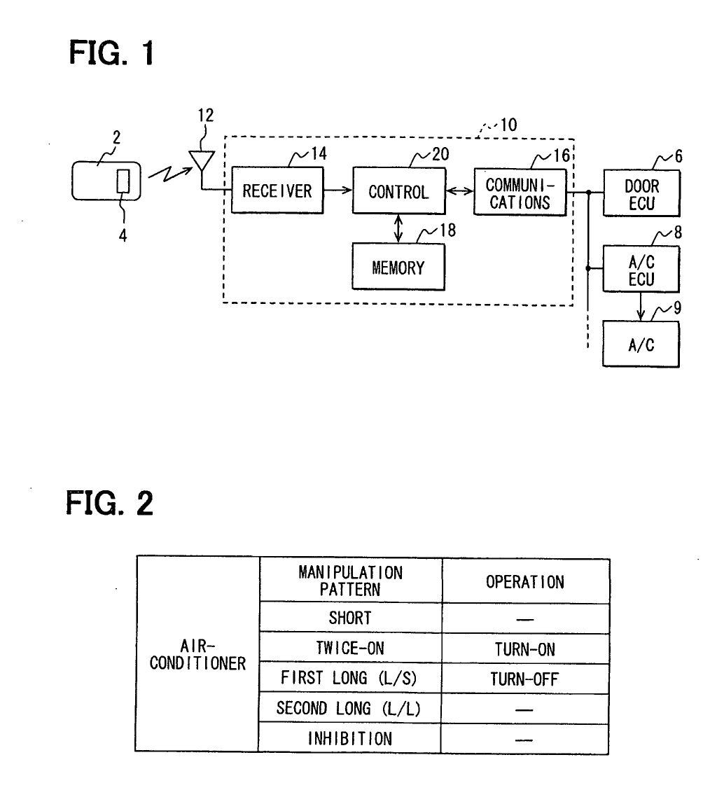

Referring to FIG. 1, an electronic control system for a vehicle includes a portable radio device (external transmitter device) 2 carried by a vehicle user, an electronic control apparatus 10, a door electronic control unit (door ECU) 6 for controlling vehicle doors (not shown), an air-conditioner electronic control unit (A/C ECU) 8 for controlling an air-conditioner 9, and the like. The air-conditioner 9 is assumed to be an in-vehicle control object. The control apparatus 10 is configured to receive, as input signals, radio transmission signals transmitted from the portable radio device 2 and switch the air-conditioner 9 to the turn-on condition and the turn-off condition. The door ECU 6 and the A/C ECU 8 are configured to electronically control the air-conditioner and door actuators, which locks/unlocks the doors and opens/closes door windows, respectively. The control apparatus 10 is connected to the ECUs 6, 8 via an in-vehicle local area network (LAN).

The portable radio device 2 has a button switch 4, which a vehicle user may manipulate by pressing down to generate and transmit the radio transmission signals corresponding to the manipulation of the user on the switch 4 (on/off condition of switch). The radio transmission signal is a switch manipulation signal (switch signal), which is kept generated as long as the switch 4 is kept generated. The control apparatus 10 is connected to a radio antenna 12, and includes a radio receiver circuit 14, a communications circuit 16, a memory circuit 18 and a control circuit 20.

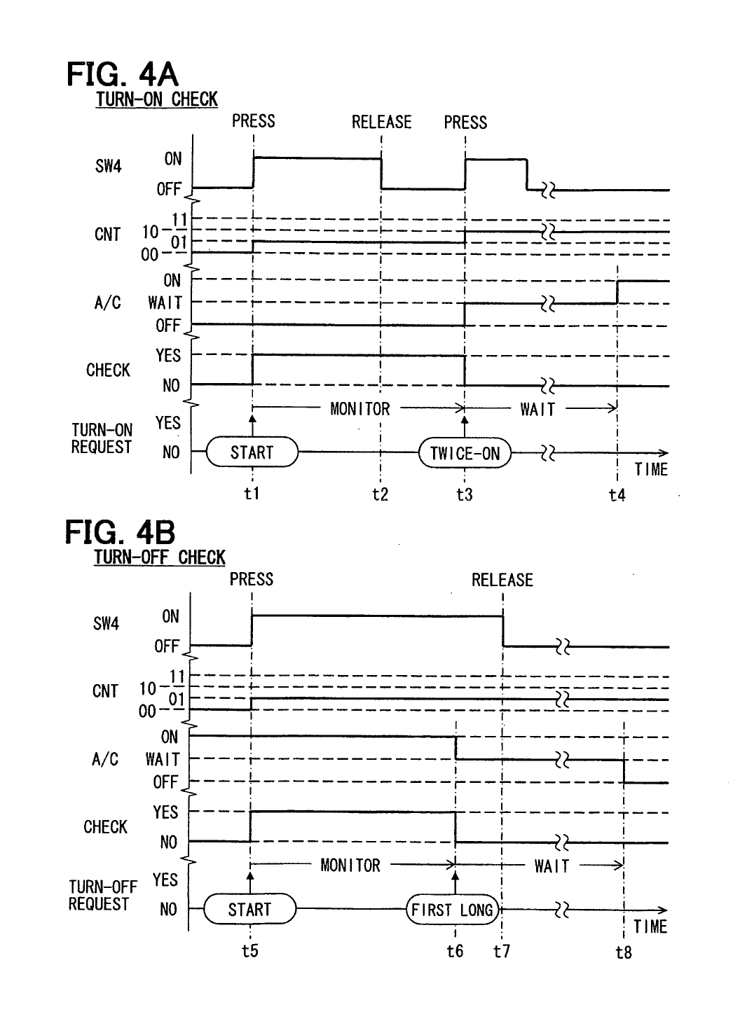

The radio receiver circuit 14 is configured to receive the radio transmission signals transmitted from the portable radio device 2 and produce reception signals (e.g.., FIGS. 4A and 4B) corresponding to the switch manipulation signals indicative of the on/off condition of the switch 4. The control circuit 20 is configured to check the reception signals to determine manipulation patterns of the switch 4 by the user, and produce an instruction signal, which is a turn-on signal (operation start signal) and a turn-off signal (operation stop signal), to the A/C ECU 8 when the manipulation patterns correspond to a predetermined turn-on pattern and a predetermined turn-off pattern, respectively. The communications circuit 16 is configured to supply the turn-on signal and the turn-off signal of the control circuit 20 to the A/C ECU 8.

The memory circuit 18 stores the predetermined turn-on pattern and the predetermined turn-off pattern that are used by the control circuit 20 in determining the manipulation pattern of the switch 4. Specifically, the memory circuit 18 stores predetermined patterns of manipulation of the switch 4, which include a short manipulation pattern, a twice-on manipulation pattern, a first long (long/short: L/S) manipulation pattern, a second long (long/long: L/L) manipulation pattern and an inhibition pattern. Of these patterns, the twice-on manipulation pattern and the first long manipulation pattern are set as the turn-on pattern and the turn-off pattern of the air-conditioner as shown in FIG. 2.

The short manipulation, first long manipulation and second long manipulation are distinguished one another based on a time interval of continued manipulation (pressing operation) of the switch 4. The twice-on manipulation is distinguished based on the number of times (two times) of manipulations of the switch 4 within a predetermined time period, and the inhibition manipulation indicates inhibition of remote control, that is, inhibition of acceptance of instruction indicated by the reception signal.

It is assumed that the twice-on manipulation pattern is set to indicate the turn-on instruction of the air-conditioner 9 and the first long manipulation pattern (L/S) is set to indicate the turn-off instruction of the air-conditioner 9. The first long manipulation pattern is an intermediate manipulation pattern (L/S), which indicates that the time period of continued pressing of the switch 4 is longer than that of the short manipulation pattern but shorter than that of the second long manipulation pattern (L/L)

When the portable radio device 2 transmits the switch manipulation signal in response to the manipulation of the switch 4, the radio receiver circuit 14 is responsively turned on upon reception of the switch manipulation signal. The radio receiver circuit 14 is turned off when it receives no switch manipulation signal. The portable radio device 2 is configured to add a count value CNT, which changes as 00, 01, 10, 11, 00 in binary code (0, 1, 2, 3 in decimal code) and so on each time the switch 4 is manipulated as shown in FIGS. 4A and 4B, to the switch manipulation signal. The radio receiver circuit 14 demodulates the count value included in the received switch manipulation signal and supplies the count value to the control circuit 20.

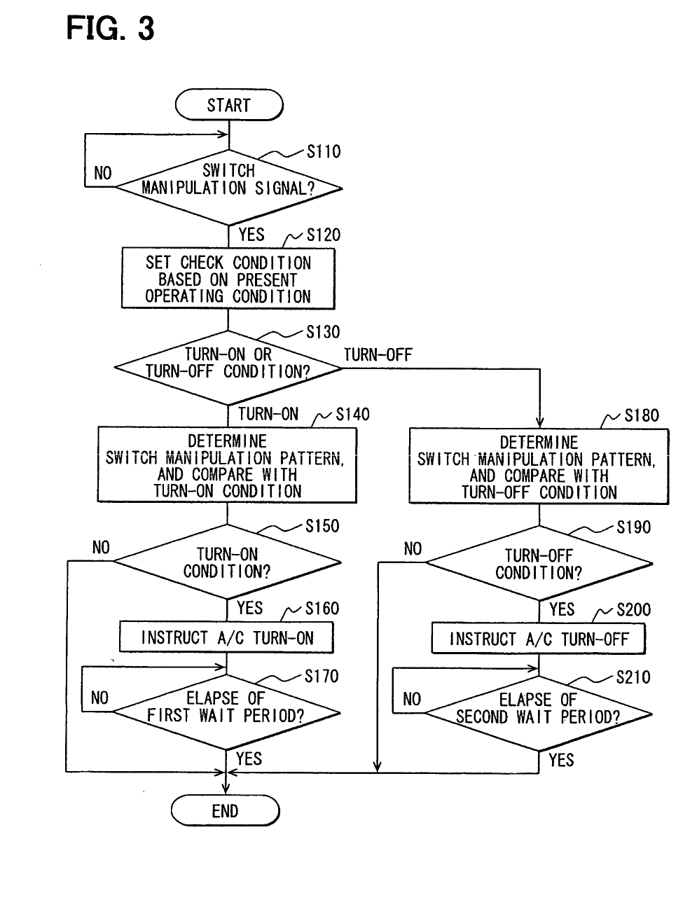

The control circuit 20 includes a microcomputer, which is programmed to execute switch manipulation signal receiving processing according to a control program stored in the memory circuit 18. This processing is executed as shown in FIG. 3 while the vehicle is at rest (parked), so that the air-conditioner 9 may be turned on or off by the A/C ECU 8 in response to the manipulation of the switch 4 of the portable radio device 2 outside the vehicle.

Referring to FIG. 3, it is first checked at S110 whether a switch manipulation signal indicating the turn-on of the switch 4 has been inputted as an input signal to the radio receiver circuit 14. If no switch manipulation signal has been received and no reception signal has been produced by the radio receiver circuit 14, S110 is repeated.

If the switch manipulation signal has been received (YES at S110), a check condition for switching the air-conditioner from the present condition (turn-on condition or turn-off condition) to the opposite condition (turn-off condition or turn-on condition) is set at S120. This check condition is for checking the switch manipulation pattern to determine whether the instruction from the switch 4 should be accepted, and is set to vary in accordance with the present operating condition of the air-conditioner 9.

If the air-conditioner 9 has already been turned on and is operating, the air-conditioner turn-on control need not be executed again even if the switch 4 is manipulated in the twice-on pattern set to turn on the air-conditioner 9. If the air-conditioner is not in operation, the air-conditioner turn-off control need not be executed again even if the switch 4 is manipulated in the first long/short manipulation pattern set to turn off the air-conditioner 9.

Therefore, at S120, the turn-off check condition is set as the manipulation pattern for accepting the instruction from the switch 4, if the air-conditioner has already been turned on and is in operation. The turn-on check condition is set as the manipulation pattern for accepting the instruction from the switch 4, if the air-conditioner has been stopped and is not in operation. Thus, at S120, the check condition is set to the manipulation pattern, which is opposite to the manipulation pattern by which the air-conditioner 9 is kept in the present operating condition.

Next, at S130, it is checked whether the check condition set at S120 is for checking the turn-on or the turn-off. If it the turn-on condition and the turn-off condition, S140 and S180 are executed.

At S140, the reception signal corresponding to the switch manipulation signal and the count value inputted from the radio receiver circuit 140 is monitored and checked to determine the switch manipulation pattern. The determined switch manipulation pattern is compared with the predetermined pattern to check whether the turn-on check condition is satisfied.

The manipulation pattern for turning on the air-conditioner is set to the twice-on manipulation in this embodiment. Therefore, as shown exemplarily in FIG. 4A, the manipulation pattern of the switch 4 is determined in sequence by detecting time t1 when the switch 4 is pressed down, time t2 when the switch 4 is released from the pressed condition and time t3 when the switch 4 is pressed again. The times t2 and t3 may be detected based on the signal level change of the switch manipulation signal and the count value CNT while measuring the time from the time t1. This determined manipulation pattern is checked if it corresponds to the check condition of the twice-on manipulation by comparing the determined pattern and the predetermined turn-on pattern.

If the determined manipulation pattern does not correspond to the check condition of the twice-on manipulation, it is determined at S150 that the turn-on check condition is not satisfied (NO). If the determined manipulation pattern corresponds to the check condition of the twice-on, it is determined at S150 that the turn-on check condition is satisfied (YES).

If the turn-on check condition is not satisfied, the processing ends, and the above processing is repeated again from S110 after a predetermined time elapse. If the turn-on check condition is satisfied, an air-conditioner turn-on instruction signal is produced to the communications circuit 16 at S160, so that the turn-on instruction signal is applied to the A/C ECU 8. As a result, the A/C ECU 8 starts to operate the air-conditioner 9 to perform a preliminary air-conditioning operation before a user and passengers get in a vehicle compartment.

It is checked at S170 whether a predetermined first wait period has elapsed after the turn-on instruction for the air-conditioner 9 is produced at S160. If the wait period elapses at time t4 (S170: YES), the processing ends for a while and the processing is repeated from S110 again.

This wait period may be set to correspond to a first delay time, which is normally required for the air-conditioner 9 to be actually turned on and start operating after the turn-on instruction has been produced. This wait period is provided to inhibit the acceptance of the switch manipulation signal transmitted from the portable radio device 2 and received by the radio receiver circuit 14 until the air-conditioner 9 completely starts operating.

At S180, the reception signal produced from the radio receiver circuit 14 and corresponding to the witch manipulation signal and the count value are monitored to check the manipulation pattern of the switch 4 and compare the same with the turn-off check condition.

According to the present embodiment, the first long (L/S) manipulation pattern is set as the turn-off manipulation pattern. Therefore, as shown exemplarily in FIG. 4B, it is checked how long the switch 4 is continuously kept pressed from time t5 when the switch 4 is pressed. Here, the switch 4 is assumed to be kept pressed until time t7 when the switch 4 is released from the continuously pressed condition. This checking may also be made based on the signal level change of the switch manipulation signal and the count value. A predetermined time period from t5 to t6 is set as the check condition for checking whether the manipulation pattern corresponds to the first long manipulation.

If it is detected that the switch 4 is released from the pressed condition before the time t6, it is determined that the switch manipulation pattern is not the first long manipulation pattern and does not satisfy the turn-off condition. If it is detected that the switch 4 is kept pressed continuously even at time t6, it is determined that the switch manipulation pattern is the first long manipulation pattern and satisfies the turn-off check condition.

If the turn-off check condition is not satisfied (S190: NO), the processing is ended and later repeated again from S110. If the turn-off check condition is satisfied (S190: YES), an air-conditioner turn-off instruction is produced at S200 to the communications circuit 16 so that the turn-off instruction is applied to the A/C ECU 8. As a result, the A/C ECU 8 turns off the air-conditioner 9 to stop the air-conditioning operation.

After the turn-off instruction signal has been issued, it is checked at S210 whether a predetermined second wait period has elapsed. If the predetermined second time period has elapsed, the processing is terminated at this moment.

This second wait period is set to correspond to a second delay time, which the A/C ECU 8 needs to complete stopping the air-conditioner operation after receiving the turn-off instruction signal through the communications circuit 16. This second wait period is provided to inhibit the acceptance of the switch manipulation signal transmitted from the portable radio device 2 and received by the radio receiver circuit 14 until the air-conditioner 9 completely stops operating.

As described above, according to the electronic control apparatus 10, when the switch manipulation signal is received through the radio receiver circuit 14, the control circuit 20 sets the check condition for switching the air-conditioner 9 from the present operating condition to the other operating condition as the check condition of the manipulation pattern for determining whether the instruction from the switch 4 should be accepted. Thereafter, the control circuit 20 checks the manipulation pattern of the switch 4 based on the change of the switch manipulation signal and the count value, and turns on or turns off the air-conditioner 9 when the manipulation pattern corresponds to the check condition indicating the acceptable manipulation pattern.

Therefore, if the manipulation pattern of the switch 4 is the pattern that controls the air-conditioner 9 to the present operating condition, it is determined at S140 or S180 that such a manipulation pattern is not acceptable and the corresponding control is inhibited to maintain the present operating condition of the air-conditioner 9.

As a result, any operation that controls the air-conditioner 9 to the same operating condition as the present operating condition is inhibited thereby to reduce consumption of the battery power, which will be otherwise consumed unnecessarily. Since the manipulation pattern of the switch 4 is checked by the control apparatus 10, the portable radio device 2 need not have such a check function and is only required to transmit the signal corresponding to the switch manipulation.

Further, the control circuit 20 inhibits the processing of the switch manipulation signal for the predetermined wait time periods at S170 and S210 after producing the instruction signals for turning on and turning off the air-conditioner 9 at S160 and S200, respectively. As a result, even if the portable radio device 2 transmits any switch manipulation signal under the condition that the air-conditioner 9 is in a process of turning on or turning off the air-conditioner 9, such an instruction will not be accepted so that the air-conditioner 9 will not be controlled to a condition, which the user does not intend.

In addition, in checking the manipulation pattern of the switch 4, the count value included in the radio transmission signal from the portable radio device 2 is used in addition to the switch manipulation signal included in the radio transmission signal. As a result, even if the radio receiver circuit 14 is disabled or interrupted to receive the radio transmission signal from the portable radio device 2 temporarily for some reason, for example by jamming waves, the manipulation pattern of the switch 4 will be determined normally as far as the period of such jamming is short.

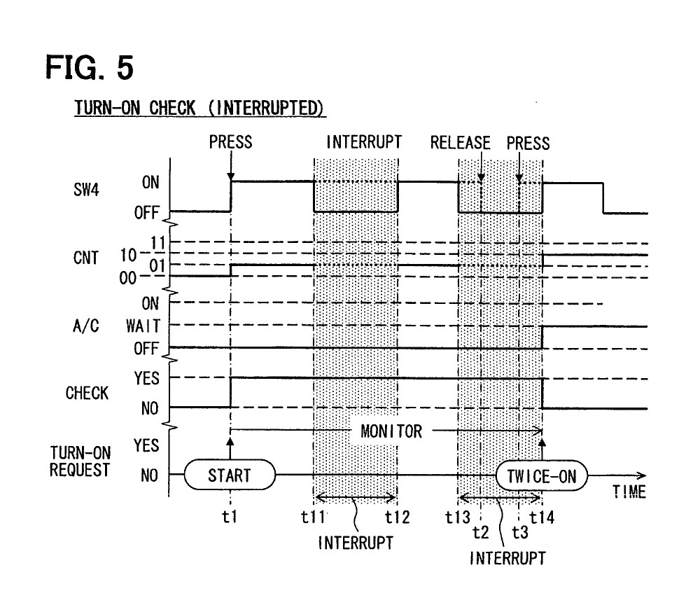

Specifically, it is assumed here that, as exemplarily shown in FIG. 5, the radio communications between the portable radio device 2 and the control apparatus 10 is interrupted while the control apparatus 10 is checking the manipulation pattern of the switch 4 based on the switch manipulation signal received from the portable radio device 2. The interruption is assumed to arise from time t11 to time t12 after the switch 4 has been pressed first at time t1 and until the switch 4 is released from the pressed condition at time t2. In this case, the switch manipulation signal (SW4) received at the radio receiver circuit 14 will change to fall at time t11 and rise at time t12 as shown by a solid line, while the switch 4 is actually kept pressed down continuously as shown by a dotted line.

During the period (t1 to t12) of interruption, the count value CNT does not change from 01 (1) at time t12 when the interruption disappears. As a result, it can be determined that the switch 4 has been pressed continuously during this period of interruption.

It is also assumed that the communication is interrupted again from time t13 to time t14 covering the period from time t2 when the switch 4 is released to time t3 when the switch 4 is pressed again. In this case, at time t14 when the interruption disappears, the count value CNT increases to 10 (2). As a result, it can be determined that the manipulation pattern corresponds to the twice-on pattern, and the air-conditioner turn-on control can be started as the user intended.

As described above, erroneous control of the air-conditioner 9 due to interruption of the radio transmission signal of the portable radio device 2 can be prevented thereby to enhance the reliability of the electronic control system. In the various processing of the control circuit 20, S120 operates as a setting section, S130 to S150, S180 and S190 operate as a check section, S160 and S200 operate as a control section, and S170 and S210 operate as a signal input inhibit section. The radio receiver circuit 14 operates as a receiver section.

The present embodiment may be modified in many other ways without departing from the spirit of the present invention.

For instance, the control object may be a door lock system, which is mounted in a vehicle and controlled by a door ECU to lock and unlock vehicle doors. Further, the control object may be an engine, which is mounted in a vehicle and controlled by an engine ECU. In addition, a manipulation switch may be provided in a vehicle and connected directly to an electronic control apparatus to instruct control of vehicle-mounted systems.

Still further, the control circuit 20 may be configured to check all manipulation patterns of the switch 4 based on the radio signals received from the portable radio device thereby to determine the corresponding operations of the control object stored in the memory circuit 18, and to control thereafter the control object to perform the corresponding operation only when the corresponding operation is different from the present condition of the control object.

What is claimed is:

1. An electronic control apparatus for controlling a control object mounted in a vehicle in response to an input signal from a manipulation switch, the apparatus comprising:
a setting section configured to set an instruction, as an acceptable instruction, that changes the control object from a present condition to a different condition;
a check section configured to check whether the input signal from the manipulation switch corresponds to the acceptable instruction; and
a control section configured to control the control object as instructed by the input signal from the manipulation switch, when the input signal from the manipulation switch is determined to be the acceptable instruction.

2. The electronic control apparatus according to claim 1, further comprising:
a signal input inhibit section configured to inhibit input of the input signal from the manipulation switch for a predetermined wait period when the check section determines that the input signal from the manipulation switch corresponds to the acceptable instruction.

3. The electronic control apparatus according to claim 1, further comprising:
a receiver section configured to receive a switch signal, which is transmitted wirelessly from a portable device including the manipulation switch while the manipulation switch is manipulated; and
the check section being configured to check a manipulation pattern of the manipulation switch based on a reception signal produced by the receiver section to determine an instruction, and check whether the instruction of the reception signal corresponds to the acceptable instruction.

4. The electronic control apparatus according to claim 3, wherein:
the switch signal transmitted from the portable device includes a count value indicative of the number of times of manipulating the manipulation switch; and
the check section is configured to determine the manipulation pattern of the manipulation switch based on changes of the reception signal produced from the receiver section and the count value included in the reception signal.

5. An electronic control system for controlling a control object mounted in a vehicle from an outside of the vehicle, the system comprising:
a portable radio device having a manipulation switch to be manipulated by a vehicle user to transmit a radio signal that changes a signal level thereof in correspondence to manipulation of the vehicle user and includes a count value indicative of the number of manipulations of the switch;
a memory circuit storing a predetermined relation between manipulation patterns of the manipulation switch and corresponding operations of the control object; and
a control apparatus configured to check a manipulation pattern of the switch based on the radio signal received from the portable radio device thereby to determine a corresponding operation of the control object with reference to the predetermined relation stored in the memory circuit, and to control the control object to perform the corresponding operation only when the corresponding operation is different from a present condition of the control object.
